(19) United States
(12) Patent Application Publication
(10) Pub. No.: US 2026/0021613 A1
(43) Pub. Date: Jan. 22, 2026

(54) VEHICLE PANEL AND METHOD FOR MANUFACTURING VEHICLE PANEL

(71) Applicant: TOYODA GOSEI CO., LTD., Kiyosu-shi (JP)

(72) Inventors: Kazuhisa TAKAHASHI, Kiyosu-shi (JP); Hitoshi HORIBE, Kiyosu-shi (JP); Takumi ISHII, Kiyosu-shi (JP); Ryota OSHIMURA, Kiyosu-shi (JP); Keisuke NISHIOKA, Kiyosu-shi (JP)

(21) Appl. No.: 19/249,071

(22) Filed: Jun. 25, 2025

(30) Foreign Application Priority Data
Jul. 22, 2024 (JP) 2024-116907

(51) Int. Cl. B29C 45/16

(52) U.S. Cl. CPC B29C 45/162; B29K 2995/0026

(57) ABSTRACT

A vehicle panel includes a first layer formed from plastic and molded using a first mold, and a second layer formed from plastic and molded on a front surface of the first layer using a second mold. The second layer has a front surface including surface regions continuous with one another in a predetermined direction. The surface regions include a first region and a second region. A first grained surface molded using the first mold is formed in a region of the front surface of the first layer corresponding to the second region. A second grained surface molded using the second mold is formed in the first region. A third grained surface having a smaller grained surface height than second grained surface is formed in the second region. The third grained surface includes a sink mark resulting from molding of the second layer on the first grained surface.

### CROSS-REFERENCE TO RELATED APPLICATIONS

This application is based upon and claims the benefit of priority from Japanese Patent Application No. 2024-116907, filed on Jul. 22, 2024, the entire contents of which are incorporated herein by reference.

### BACKGROUND

### 1. Field

The following description relates to a vehicle panel and a method for manufacturing a vehicle panel.

### 2. Description of Related Art

Japanese Laid-Open Patent Publication No. 2012-236389 discloses a plastic ornamental component, which is a typical example of a vehicle panel. Such a plastic ornamental component includes a plastic base formed by injection molding. A grained surface including fine irregularities is formed on a front surface of the base. The grained surface is formed by transferring irregularities formed in advance on a molding surface of a mold for the base during molding of the base.

In order to form finer irregularities on the grained surface of the base and improve the degree of freedom for design expression, it is necessary to form finer irregularities on the molding surface of the mold. However, there is a limitation in forming fine irregularities on the molding surface of the mold by machining. Therefore, there is room for improvement in terms of the degree of freedom for design expression of the vehicle panel.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A vehicle panel in accordance with one general aspect of the present disclosure includes a first layer and a second layer. The first layer is formed from plastic and is molded using a first mold. The second layer is formed from plastic and is molded on a front surface of the first layer using a second mold. The second layer has a front surface including surface regions continuous with one another in a predetermined direction. The surface regions include a first region and a second region. A first grained surface molded using the first mold is formed in a region of the front surface of the first layer corresponding to the second region. A second grained surface molded using the second mold is formed in the first region. A third grained surface having a smaller grained surface height than the second grained surface is formed in the second region. The third grained surface includes a sink mark resulting from molding of the second layer on the first grained surface.

A method for manufacturing a vehicle panel in accordance with another general aspect of the present disclosure includes molding, using a first mold, a first layer formed from plastic. The method further includes molding, using a second mold, a second layer formed from a visible-light-transmissive plastic on a front surface of the first layer. The second layer has a front surface including surface regions continuous with one another in a predetermined direction. The surface regions include a first region and a second region. The molding the first layer includes forming, using the first mold, a first grained surface in a region of the front surface of the first layer corresponding to the second region. The forming the second layer includes forming, using the second mold, a second grained surface in the first region. The forming the second layer further includes forming a third grained surface having a smaller grained surface height than the second grained surface in the second region. The third grained surface includes a sink mark formed in the second region.

Other features and aspects will be apparent from the following detailed description, the drawings, and the claims.

### BRIEF DESCRIPTION OF THE DRAWINGS

FIG. 1 is a schematic plan view illustrating part of a vehicle panel in accordance with an embodiment.

FIG. 2 is a cross-sectional view taken along line 2-2 shown in FIG. 1.

FIG. 3 is a schematic cross-sectional view of a state in which a first layer is molded in a first mold.

FIG. 4 is a schematic cross-sectional view of a state in which a second mold is clamped with the first layer located in the second mold.

FIG. 5 is a schematic cross-sectional view of a state in which a second cavity in the second mold shown in FIG. 4 is filled with a thermosetting resin.

FIG. 6 is a schematic cross-sectional view of a state in which the second mold is opened after a second layer is molded as shown in FIG. 5.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment of the present disclosure will now be described with reference to the drawings.

### Vehicle Panel 11

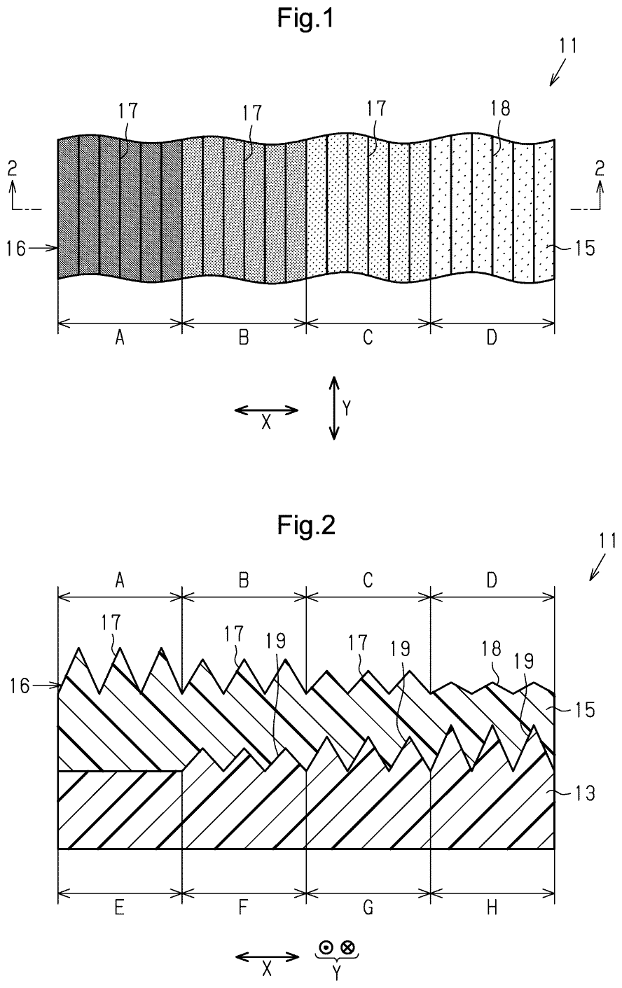

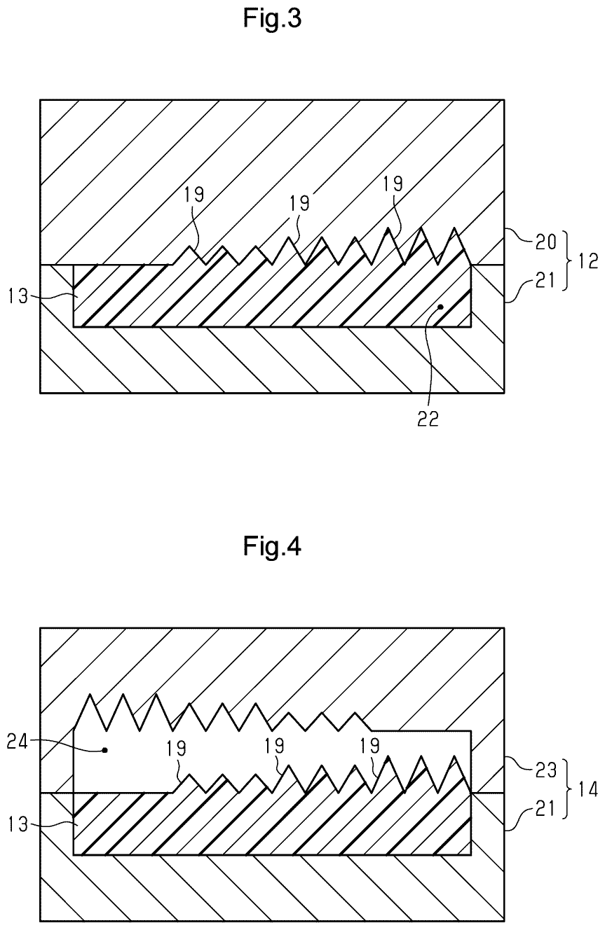

As shown in FIGS. 1 and 2, a vehicle panel 11 is used as a vehicle interior panel, such as an instrument panel or a door trim, or a vehicle exterior panel, such as a bumper or a back panel. The vehicle panel 11 includes a first layer 13 molded using a first mold 12 (refer to FIG. 3), and a second layer 15 molded on a front surface of the first layer 13 using a second mold 14 (refer to FIG. 4). The first layer 13 is formed from a thermoplastic resin that is not visible-light-transmissive. The second layer 15 is formed from a thermosetting resin that is visible-light-transmissive.

Examples of the thermoplastic resin of the first layer 13 include polyethylene (PE), polyvinyl chloride (PVC), polypropylene (PP), polystyrene (PS), acrylonitrile butadiene styrene (ABS) copolymer resin, acrylonitrile styrene (AS) copolymer resin, acrylic resin (PMMA), polybutylene terephthalate (PBT), polyethylene terephthalate (PET), polycarbonate (PC), or the like.

Examples of the thermosetting resin of the second layer 15 include thermosetting polyurethane, polyurea, unsaturated polyester, or the like. The thermosetting resin of the second layer 15 may be transparent or translucent.

The vehicle panel 11 of the present embodiment is, for example, rectangular. Hereinafter, a direction extending parallel to the long side of the vehicle panel 11 will be referred to as the predetermined direction X, and a direction extending parallel to the short side of the vehicle panel 11 will be referred to as the widthwise direction Y.

### Second Layer 15

As shown in FIGS. 1 and 2, the second layer 15 has a front surface including multiple (in the present embodiment, four) surface regions 16 continuous with one another in the predetermined direction X. The four surface regions 16 of the present example include region A, which is an example of a first region, region D, which is an example of a second region, region B, which is an example of a third region, and region C, which is another example of the third region.

The four surface regions 16 include region A and region D. Regions A to D are located side by side in the order of region A, region B, region C, and region D from one side to the other side in the predetermined direction X. Therefore, the front surface of the second layer 15 includes region B and region C located between region A and region D in the predetermined direction X.

A second grained surface 17 molded using the second mold 14 (refer to FIG. 4) is formed in regions A, B, and C of the front surface of the second layer 15. In an example, the second grained surface 17 includes irregularities extending in the widthwise direction Y. The irregularities have a cross section in which multiple triangular shapes are located side by side in the predetermined direction X. The second grained surface 17 is set to have a grained surface height of, for example, 20 μm or greater and 100 μm or less. The projections and recesses forming the second grained surface 17 are uniform in length in the predetermined direction X.

The second grained surface 17 in regions A, B, and C has a grained surface height that decreases from region A toward region D in the predetermined direction X. Specifically, the second grained surface 17 in the region A has a greater grained surface height than the second grained surface 17 in the region B, and the second grained surface 17 in the region B has a greater grained surface height than the second grained surface 17 in the region C.

A third grained surface 18 is formed in region D of the front surface of the second layer 15. The third grained surface 18 includes a sink mark resulting from molding of the second layer 15. In an example, the third grained surface 18 includes irregularities extending in the widthwise direction Y. The irregularities have a cross section in which multiple triangular shapes are located side by side in the predetermined direction X. Preferably, the third grained surface 18 is set to have a grained surface height of 0.5 μm or greater and 10 μm or less, and more preferably, 0.5 μm or greater and 5 μm or less.

That is, the third grained surface 18 has a smaller grained surface height than the second grained surface 17 in the region C. The projections and recesses forming the third grained surface 18 are uniform in length in the predetermined direction X. The front surface of the second layer 15 may include a region without a grained surface, in addition to regions A to D.

### First Layer 13

As shown in FIG. 2, the front surface of the first layer 13 includes regions E, F, G, and H that respectively correspond to regions A, B, C, and D of the second layer 15. A first grained surface 19 molded using the first mold 12 (refer to FIG. 3) is formed in regions F, G, and H of the front surface of the first layer 13.

In an example, the first grained surface 19 includes irregularities extending in the widthwise direction Y. The irregularities have a cross section in which multiple triangular shapes are located side by side in the predetermined direction X. The first grained surface 19 is set to have a grained surface height of, for example, 16 μm or greater and 334 μm or less. The projections and recesses forming the first grained surface 19 are uniform in length in the predetermined direction X.

The first grained surface 19 in regions F, G, and H has a grained surface height that increases from region A toward region D in the predetermined direction X. Specifically, the first grained surface 19 in region H has a greater grained surface height than the first grained surface 19 in region G, and the first grained surface 19 in region G has a greater grained surface height than the first grained surface 19 in region F. Region E does not include the first grained surface 19. The front surface of the first layer 13 may include another region without a grained surface, in addition to regions E to H.

In a direction orthogonal to the front surface of the first layer 13, the peaks of the triangular cross-sectional shapes of the irregularities forming the first grained surface 19 located in regions F and G of the first layer 13 correspond to the peaks of the triangular cross-sectional shapes of the irregularities forming the second grained surface 17 located in regions B and C of the second layer 15. In a direction orthogonal to the front surface of the first layer 13, the peaks of the triangular cross-sectional shapes of the irregularities forming the first grained surface 19 located in region H of the first layer 13 correspond to the peaks of the triangular cross-sectional shapes of the irregularities forming the third grained surface 18 located in region D of the second layer 15.

### Method for Manufacturing Vehicle Panel 11

The vehicle panel 11 is manufactured by integrating the second layer 15 with the front surface of the first layer 13 by in-mold coating. Specifically, the vehicle panel 11 is manufactured by performing a first layer molding step of molding the first layer 13, and a second layer molding step of molding the second layer 15 on the front surface of the first layer 13.

As shown in FIG. 3, the first layer forming step first fills a first cavity 22 formed by clamping the first mold 12 with a molten thermoplastic resin material. The first mold 12 includes a first movable mold 20 and a fixed mold 21. When the molten resin is cooled and solidified, the first layer 13 is molded in the first mold 12. In this case, as shown in FIGS. 2 and 3, the first movable mold 20 having a grained surface pattern forms the first grained surface 19 in regions F, G, and H of the front surface of the first layer 13. Subsequently, the first mold 12 is opened. Then, the first movable mold 20 is replaced by a second movable mold 23, which will be described below, for the second layer molding step.

As shown in FIG. 4, the second layer forming step clamps the second mold 14 that includes the second movable mold 23 and the fixed mold 21. This forms a second cavity 24 between the front surface of the first layer 13 and an inner surface of the second movable mold 23 in the second mold 14.

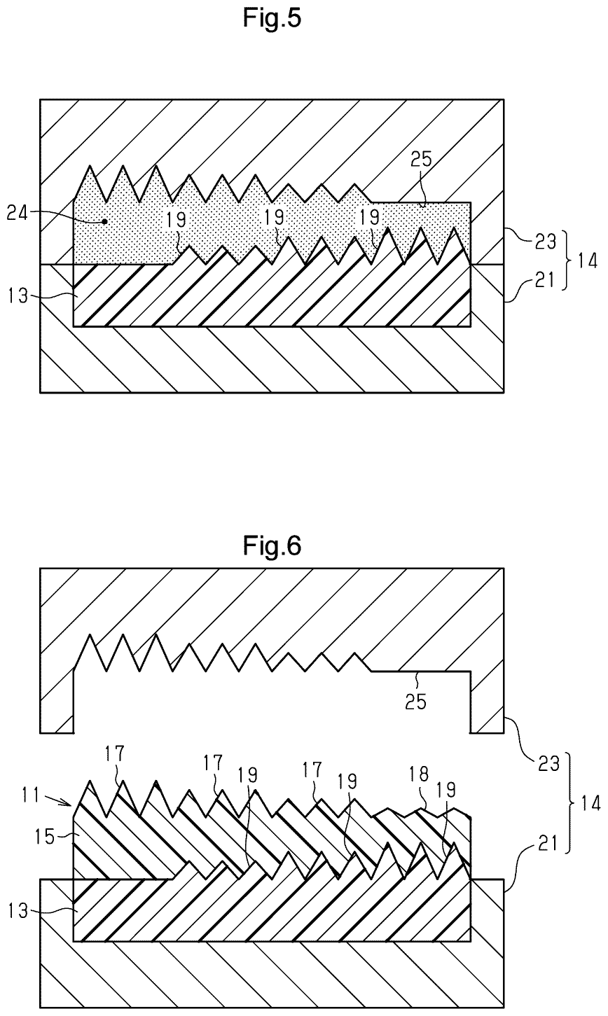

Subsequently, as shown in FIG. 5, the second cavity 24 is filled with a thermosetting resin material that is visible-light-transmissive. As shown in FIGS. 2 and 5, when the thermosetting resin material filling the second cavity 24 is cured as a result of chemical reaction, the second layer 15 becomes integrated with the front surface of the first layer 13 to form the vehicle panel 11.

In this case, as shown in FIGS. 2 and 5, the second movable mold 23 having a grained surface pattern forms the second grained surface 17 in regions A, B, and C of the surface of the second layer 15. The second movable mold 23 includes a flat surface 25, which does not have a grained surface pattern, at a portion corresponding to region D of the front surface of the second layer 15.

Further, a sink mark (irregularities) formed in region D of the front surface of the second layer 15 serves as the third grained surface 18. The sink mark is formed in correspondence with the first grained surface 19 located in region H of the front surface of the first layer 13 below region D. In other words, the sink mark formed in region D of the front surface of the second layer 15, which is located above region H of the front surface of the first layer 13, serves as the third grained surface 18 having a smaller grained surface height than the second grained surface 17.

As shown in FIG. 6, the second mold 14 is then opened to extract the vehicle panel 11.

### Operation of the Embodiment

As shown in FIGS. 1 and 2, in the vehicle panel 11, the grained surface height of the front surface of the second layer 15 gradually decreases from region A toward region D, the grained surface height of the front surface of the first layer 13 gradually decreases from region H toward region F, and region E is without a grained surface. Thus, when the vehicle panel 11 is viewed from the front surface of the second layer 15, light is reflected by the front surface of the first layer 13 and the front surface of the second layer 15 in different manners that change in opposite directions with respect to an axis parallel to the predetermined direction X. This allows the vehicle panel 11 to express subtle gradations in appearance.

In this case, the vehicle panel 11 uses the sink mark formed in the front surface of the second layer 15, and serving as the third grained surface 18, as part of the design. Although a sink mark is typically considered as a defect in the appearance, the vehicle panel 11 uses the sink mark as part of the design. This reduces defects in the appearance of the vehicle panel 11 caused by sink marks.

Furthermore, when the vehicle panel 11 is located where light of a light source, such as indoor lighting, is soft, the light passing through the second layer 15 and reflected on the front surface of the first layer 13 readily reaches the eyes of a viewer, so that the gradations obtained by the first grained surface 19 are easy to perceive. On the other hand, when the vehicle panel 11 is located where light of a light source, such as sun, is bright, the light reflected on the front surface of the second layer 15 readily reaches the eyes of a viewer, so that the gradations obtained by the second grained surface 17 and the third grained surface 18 are easy to perceive. That is, the appearance of the vehicle panel 11 changes depending on the intensity of light from a nearby light source. This allows the vehicle panel 11 to express more than one design.

### Advantages of the Embodiment

The above-described embodiment has the following advantages.

(1) The vehicle panel 11 includes the first layer 13 formed from plastic and molded using the first mold 12, and the second layer 15 formed from plastic and molded on the front surface of the first layer 13 using the second mold 14. The second layer 15 has the front surface including multiple surface regions 16 continuous with one another in the predetermined direction X. The surface regions 16 include region A and region D.

The first grained surface 19 molded using the first mold 12 is formed in region H of the front surface of the first layer 13 corresponding to region D. The second grained surface 17 molded using the second mold 14 is formed in region A. The third grained surface 18 having a smaller grained surface height than the second grained surface 17 is formed in region D. The third grained surface 18 includes a sink mark resulting from molding of the second layer 15 on the first grained surface 19

Typically, when a grained surface is formed by a mold that includes a grained surface pattern formed by machining, the grained surface height is approximately 20 μm or greater. However, when a grained surface is formed by a sink mark resulting from molding of plastic, the grained surface height may be 10 μm or less. In this respect, with the above structure, the second grained surface 17 and the third grained surface 18 having grained surface heights in different ranges are continuously formed on the front surface of the second layer 15. Therefore, designs having a wider range of grained surface height can be expressed. This improves the freedom of design for design expression.

(2) In the vehicle panel 11, the second layer 15 is visible-light-transmissive. The front surface of the second layer 15 includes region B and region C, as the surface regions 16, between region A and region D in the predetermined direction X. The second grained surface 17 is formed in regions B and C. The first grained surface 19 is formed in regions F and G that correspond to regions B and C of the front surface of the first layer 13. The first grained surface 19 has a grained surface height that increases from region A toward region D in the predetermined direction X. The second grained surface 17 has a grained surface height that decreases from region A toward region D in the predetermined direction X.

With this structure, the front surface of the first layer 13 and the front surface of the second layer 15 reflect light in different manners that change in opposite directions with respect to an axis parallel to the predetermined direction X. This allows for expression of subtle gradations in appearance.

### MODIFIED EXAMPLES

The above embodiment may be modified as follows. The above embodiment and the following modifications can be combined as long as the combined modifications remain technically consistent with each other.

Region B of the front surface of the second layer 15 and region F of the front surface of the first layer 13 may be omitted.

Regions C of the front surface of the second layer 15 and region G of the front surface of the first layer 13 may be omitted.

Regions B and C of the front surface of the second layer 15 the regions F and G of the front surface of the first layer 13 may be omitted.

Three or more regions, including regions B and C, may be arranged on the front surface of the second layer 15 as the third regions. In this case, three or more regions, including regions F and G, that correspond to the above three or more regions of the front surface of the second layer 15 are arranged on the front surface of the first layer 13.

Region E of the front surface of the first layer 13 may include the first grained surface 19. In this case, it is preferred that the first grained surface 19 in region E have a smaller grained surface height than the first grained surface 19 in region F.

At least one of the first grained surface 19, the second grained surface 17, and the third grained surface 18 may include projections and recesses that are not uniform in length in the predetermined direction X.

The projections and recesses forming the first grained surface 19, the second grained surface 17, and the third grained surface 18 may have, for example, quadrilateral or semicircular cross-sectional shapes.

The first layer 13 may be formed from a resin material that is visible-light-transmissive. In this case, the vehicle panel 11 becomes visible-light-transmissive. Accordingly, the vehicle panel 11 may be used as, for example, a resin glass.

The second layer 15 may be formed from a resin material that is not visible-light-transmissive.

The front surface of the second layer 15 may include a flat portion, which is without a grained surface, between region A and region B, between region B and region C, or between region C and region D.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle panel, comprising:
a first layer formed from plastic and molded using a first mold; and
a second layer formed from plastic and molded on a front surface of the first layer using a second mold, wherein
the second layer has a front surface including surface regions continuous with one another in a predetermined direction, the surface regions including a first region and a second region;
a first grained surface molded using the first mold is formed in a region of the front surface of the first layer corresponding to the second region,
a second grained surface molded using the second mold is formed in the first region, and
a third grained surface having a smaller grained surface height than the second grained surface is formed in the second region, the third grained surface including a sink mark resulting from molding of the second layer on the first grained surface.

2. The vehicle panel according to claim 1, wherein
the second layer is visible-light-transmissive,
the front surface of the second layer includes a third region, as another one of the surface regions, between the first region and the second region in the predetermined direction;
the second grained surface is formed in the third region,
the first grained surface is formed in a region of the front surface of the first layer corresponding to the third region,
the first grained surface has a grained surface height increasing from the first region toward the second region in the predetermined direction, and
the second grained surface has a grained surface height decreasing from the first region toward the second region in the predetermined direction.

3. A method for manufacturing a vehicle panel, the method comprising:
molding, using a first mold, a first layer formed from plastic; and
molding, using a second mold, a second layer formed from a visible-light-transmissive plastic on a front surface of the first layer, the second layer having a front surface including surface regions continuous with one another in a predetermined direction, the surface regions including a first region and a second region, wherein
the molding the first layer includes forming, using the first mold, a first grained surface in a region of the front surface of the first layer corresponding to the second region; and
the forming the second layer includes
forming, using the second mold, a second grained surface in the first region; and
forming a third grained surface having a smaller grained surface height than the second grained surface in the second region, the third grained surface including a sink mark formed in the second region.
